(19) United States
(12) Patent Application Publication
(10) Pub. No.: US 2003/0142079 A1
(43) Pub. Date: Jul. 31, 2003

(54) Computer keyboard key identifiers

(75) Inventor: Garrett Storm Dunker, Phoenix, AZ (US)

Correspondence Address: SEVENTH DAY SKYSTORM, PMB 546, 4802 E. RAY RD. SUITE 23, PHOENIX, AZ, 85044, US

(73) Assignee: Seventh Day SkyStorm Inc., Phoenix, AZ (US)

(21) Appl. No.: 09/683,616

(22) Filed: Jan. 25, 2002

(51) Int. Cl. G09G 5/00

(52) U.S. Cl. 345/168

(57) ABSTRACT

The invention embodies touch identification techniques to aid in recognizing computer keyboard keys. This method of key signing will reduce normal typing time for keyboarders by eliminating the need for visual confirmation of hard to reach keys or troublesome keys. According to the invention, the keys are identified using touch sensitive attributes. These include a difference in texture, elevation, material, or temperature, a vibration sensor, a plurality or combination of these, and any other method that alters keyboard key properties for the purpose of touch recognition. The identifier must have a contrast of physical properties significant enough such that the key can be recognized without looking.

### BACKGROUND OF INVENTION

The common human-computer interface for text input is the computer keyboard. Through widespread use of this hardware, several innovations have taken place to make keyboarding use more efficient and more comfortable.

Traditional keyboards incorporate small elevations located on the F and J keys for the purpose of home row identification without looking. This eliminates the time required for the keyboarder to take their eyes off the display screen, locate home row, ASDF and JKL;, and continue their work. These are too small to aid in rapid identification for when the fingers are first placed on the keyboard, but work well when the fingers are typing and function by reminding the user that his fingers are indeed on home row. Braille keyboards separate all keys uniquely, but most users are not familiar with that language. Some tab and enter keys of keyboards utilize a dual elevation key. One elevation is even with the normal plane of keys and a second recessed below that plane. The result of this feature is a distinguishable hard to reach key. The disadvantage of this is that it requires a more extreme reach since the lowered level partitions the key vertically and requires a reach past this point to identify the key.

Modifying key positions and locations is another method for key identification. A rearrangement of keys from the universal standard keyboard minimizes the reach for distant keys and makes them more manageable. There are numerous patents on the arrangement of keys to be more practical for users. These designs, however, require a substantially different keyboard than the universal standard.

It is the object of the invention to establish rapid touch identification techniques for hard to reach or hard to distinguish keys in order to speed the process of normal keyboarding.

### SUMMARY OF INVENTION

The present invention will increase typing efficiency beyond that which is currently capable on universal keyboards by employing the use of key identification techniques.

The increase in keyboarding efficiency results from improvements pertaining to the ability to recognize difficult to reach keys or confusing keys for any keyboard. This is possible by adding touch sensitive attributes to the keys. Touch sensitive attributes include difference in material, texture, elevations, temperatures, vibrations, or any other method that would uniquely distinguish a key by touch. These attributes particularly help in eliminating the need for visual key confirmation, and preventing the backspacing due to mis-typed letters.

This invention would be especially useful for laptop keyboards, since keys are smaller and key confusion is more common.

The preferred embodiment of the invention would be a change in key texture from the traditional smooth plastic to a gripable rubber or a fuzzy material. This new material is raised to a different elevation on the key and shaped as a thin bar or a plurality of circles. In aiming for a sense of a non-cluttered keyboard, the invention would best be used with only one type of altered key means. To achieve optimal usage of the identifiers, they should be arranged such that keys are not adjacent to each other in order to avoid possible mistaken keystrokes.

The previous description of the preferred embodiment can be better understood when accompanied by the following drawings.

### BRIEF DESCRIPTION OF DRAWINGS

FIG. 1 is a perspective view of a portable computer fitted with key indicators.

FIG. 2 is a perspective view of methods of key identification.

FIG. 3 is a perspective view of a portable computer fitted with a keyboard indicator.

### DETAILED DESCRIPTION

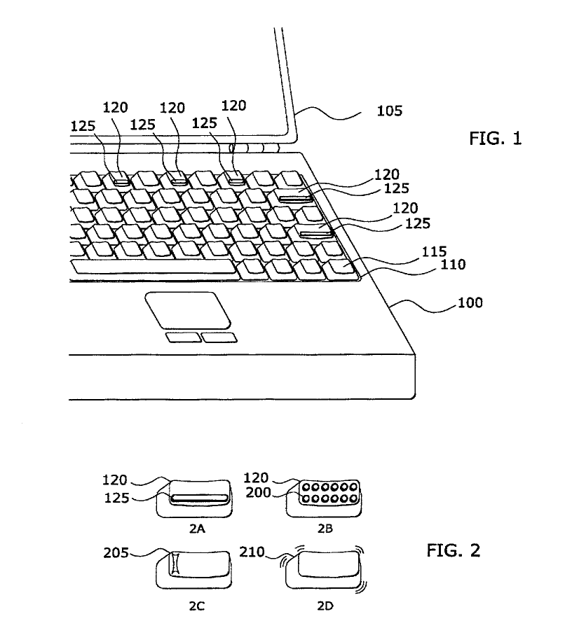

FIG. 1 shows a portable computer 100 with graphic display 105, and keyboard 110. The keyboard keys 115 of keyboard 110 are in the typical universal arrangement. Keyboard keys 115 that have been modified to allow for identification through touch sensory are shown as identified keys 120. Keyboard key identifiers 125 are raised elevation identifiers and are fitted to identified keyboard keys 120. The identified keyboard keys 120 are arranged on keyboard 110 in a manner such that two identifiers are not adjacent to each other so as to prevent confusion. A benefit of this arrangement is that the keys between are now inversely identified as the key without an identifying attribute. This would be especially useful for marking the even and odd numerated keys. The keyboarder can be confident that he or she is definitely not pressing one of the identified keys 120.

Methods of key modifications for identification purposes are shown in FIG. 2. The first modification shown, FIG. 2A, is the identified keyboard key 120 from FIG. 1. This key is fitted with a raised elevation 125, which can be composed of a material either similar or dissimilar to the material of the key 120. FIG. 2B illustrates a plurality of raised elevations 200 on keyboard key 120, which also can be composed of a material either similar or dissimilar to the material of key 120. If the raised elevations 125 and 200 were composed of a different material from key 120, they would require a means of attachment via integration or adhesion. FIG. 2C shows a distinctive material key 205. The material of the entire key 205 is composed of a different material relative to the normal keyboard keys 115. A key made of metal would give the impression of a different temperature relative to the surrounding keys. A key made entirely soft or fuzzy would be distinguishable by touch through texture. The last key, illustrated by FIG. 2D, is a vibrating key 210. The vibrating key 210 could be continuously vibrating or could vibrate in response to a light touch.

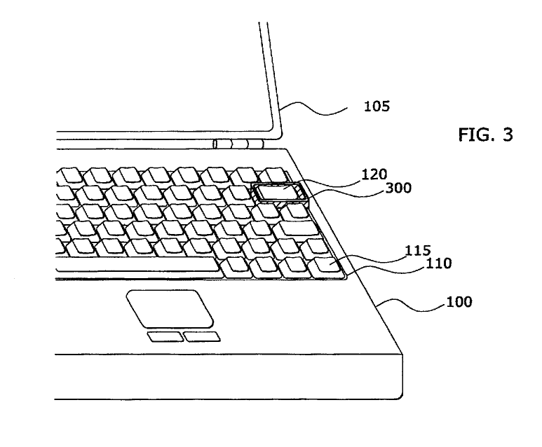

FIG. 3 is an illustration of keyboard 110 with a wall modification 300 on portable computer 100 that aids in identifying a keyboard key 120 through isolation. The keyboarder would feel a wall when his or her finger is close to the destination key and would consequently be able to identify the destination key.

1. A human computer keyboard interface device comprising:
(a) a plurality of input keys,
(b) an indicator for identification means for one or more of said keys, whereby said indicator identifies said keys through a means of touch sensitivity,
(c) a placement of said indicator or indicators such that typing efficiency is optimized.

2. An indicator for identifying keyboard keys of claim 1 using touch sensitivity by means of key alteration comprising:
(a) a difference in elevation on all or part of said keys,
(b) a difference in texture on all or part of said keys,
(c) a difference in material on all or part of said keys,
(d) a difference in temperature on all or part of said keys,
(e) a sensor activated key,
where said sensor initiates a vibration of said key when touched by a keyboarder,
(f) any plurality of said elevations, said textures, said materials, said temperatures, or said sensors, or
(g) any combination of said elevations, said textures, said materials, said temperatures, or said sensors.

3. An indicator for identifying keyboard keys of claim 1 using touch sensitivity by means of keyboard alteration comprising a wall that partly or entirely surrounds said key.
